(19) United States
(12) Patent Application Publication
(10) Pub. No.: US 2005/0019556 A1
(43) Pub. Date: Jan. 27, 2005

(54) Labeling and authentication of metal objects

(75) Inventors: R. Griffith Freeman, Mountain View, CA (US); Patrick C. Smith, Mountain View, CA (US); Michael J. Natan, Los Altos, CA (US)

Correspondence Address: SWANSON & BRATSCHUN L.L.C., 1745 SHEA CENTER DRIVE, SUITE 330, HIGHLANDS RANCH, CO, 80129, US

(73) Assignee: SurroMed, Inc.

(21) Appl. No.: 10/870,482

(22) Filed: Jun. 17, 2004

Related U.S. Application Data
(60) Provisional application No. 60/565,734, filed on Apr. 26, 2004.
(60) Provisional application No. 60/479,286, filed on Jun. 17, 2003.

(51) Int. Cl. B05D 1/12; B32B 9/04

(52) U.S. Cl. 428/328; 427/7; 427/180; 428/447; 428/458

(57) ABSTRACT

Metal objects (e.g., jewelry) are labeled with encoded metal nanoparticles for anti-counterfeiting and authentication purposes. Particles are attached by one a variety of different chemical or film-forming methods and subsequently read and decoded by optical microscopy for object identification.

### CROSS-REFERENCE TO RELATED APPLICATIONS

This application claims the benefit of U.S. Provisional Application No. 60/479,286, entitled Labeling and Authentication of Metal Objects, filed Jun. 17, 2003 and also claims the benefit of U.S. Provisional Application No. 60/565,734, entitled Labeling and Authentication of Metal Objects, filed Apr. 26, 2004. The disclosure of these applications, and all patents, patent applications, and publications referred to herein, is incorporated by reference herein in its entirety.

### FIELD OF THE INVENTION

The present invention relates generally to labeling of objects for authentication, anti-counterfeiting, brand security, and supply chain tracking applications. More particularly, it relates to methods for affixing encoded micro- or nanoscale particles to metal objects such as machine parts, jewelry, or other luxury goods for subsequent reading and decoding.

### BACKGROUND OF THE INVENTION

Many luxury and brand items are subject to counterfeiting or product diversion, resulting in significant loss of revenue for the brand owner. This problem is commonly addressed by tagging objects with robust and covert identification labels. In some cases, the labels are used to determine whether an item claimed to be a particular brand or object is genuine. In other applications, genuine products are diverted to illegal or improper channels of commerce, and the tags help verify the identity, origin, and history of such products. A variety of materials are available commercially to tag objects covertly for subsequent identification, including labels of various complexity; coatings bearing dyes, biological molecules, or other additives; and trace levels of detectable substances mixed into an object. The tags are applied to or incorporated into the products and later identified using optical, spectroscopic, or chemical techniques. Desired characteristics of these methods include ease of tagging, large numbers of distinct labels or codes, and ease and low expense of reading the labels.

Metal objects and surfaces, such as antique and high-end jewelry, machine parts, metal containers, and numerous others, present specific difficulties for tagging technologies. Dyes, inks, and biological molecules typically cannot be applied to the objects in a manner that withstands contact. More durable methods such as labeling, etching, engraving, stamping, or coating are common. While these methods may be useful for some applications, in many cases they are too expensive to apply or read and cause more object damage than is acceptable. Moreover, they are typically not covert and are relatively easy to counterfeit. Thus, there is still a need for metal tagging methods that provide inexpensive, robust, non-damaging, and covert tags that are easily applied, read with an inexpensive reader, and provide a large number of unique codes.

### SUMMARY OF THE INVENTION

The present invention addresses this need by providing methods for labeling metal surfaces for identification. In one set of embodiments, the present invention provides methods for labeling a metal surface for identification by chemically attaching to the surface an encoded metal particle. Suitable surfaces include curved or rough surfaces or the surface of a piece of jewelry, among others. The particle is attached in such a manner that it can be detected by optical microscopy while attached to the surface. The particle can be attached via an attachment compound having at least two functional groups such as thiol groups or amine groups (e.g., a dithiol such as 1,4-benzenedimethanethiol). The attachment compound can be formed from two or more starting compounds, each having at least two functional groups; for example, suitable starting compounds include poly(L-lysine) and carboxy-terminated alkanethiols. The attachment compound can also be polymeric.

In an alternative set of embodiments, the present invention provides methods for labeling a metal surface for identification by depositing on the surface an encoded metal particle that has been at least partially coated with a film-forming substance. The particle can be coated before or after deposition, and the resulting attached particle can be detected by optical microscopy. In one embodiment, the film-forming substance has at least one functional group capable of bonding to the surface or to the particle; for example, it can be a silane such as 3-aminopropyltrimethoxysilane (APTMS) or 3-mercaptopropyltrimethoxysilane (MPTMS). Alternatively, the film-forming substance is a polymer, such as a poly(2-hydroxyethyl methacrylate), or a biopolymer (e.g., a protein). The method can be used to label a curved surface, a rough surface, or the surface of a piece of jewelry, among others.

### BRIEF DESCRIPTION OF THE FIGURES

FIG. 1 is a schematic illustration of a chemical attachment method according to one embodiment of the present inyention.

FIG. 2 is a schematic illustration of a multi-step chemical attachment method according to an alternative embodiment of the present invention.

FIG. 3 is a schematic illustration of a particular example of the multi-step embodiment of FIG. 2.

FIGS. 4A and 4B are schematic illustrations of film attachment methods of the present invention.

FIG. 5 is an image of particles deposited from water onto a gold-coated silicon wafer.

FIGS. 6A and 6B are images of particles deposited onto a gold-coated glass slide and covered with nail polish, acquired using a 100× air objective (FIG. 6A) and a 100× oil immersion objective (FIG. 6B). FIG. 6C is an image of the same particles after sonication of the surface, acquired with a 100× oil immersion objective.

FIGS. 7A and 7B are images of particles encapsulated in APTMS and deposited on a gold-coated glass slide, acquired with a 100× oil immersion objective and 100× air objective, respectively.

FIG. 8 is an image of particles in PHEM solution deposited onto a gold-coated glass slide.

FIG. 9A is an image of poly(L-lsyine)-coated particles deposited onto a MUA-coated gold-coated glass slide, after sonication of the surface in water, acquired using a 20× air objective.

FIGS. 9B and 9C are images of MPA- and poly(L-lsyine)-coated particles deposited onto MUA-coated gold-coated glass slides, after sonication of the surfaces in water, acquired using 20× and 100× air objectives, respectively.

FIG. 10 is an image of particles encapsulated in HSA and deposited onto a gold-coated glass slide.

FIG. 11 is an image of particles in PHEM deposited on the inside back of a stainless steel watch.

FIG. 12 is an image of particles in PHEM deposited on the inside back of a gold watch.

FIG. 13 is an image of particles in PHEM deposited on a gold earring.

FIG. 14 is an image of particles in PHEM deposited on a white gold ring.

FIG. 15 is an image of particles in PHEM deposited on the inside of a stainless steel pen barrel.

FIG. 16 is an image of a particle deposited into a blackened groove of a stainless steel watch back, acquired with a 50× air objective.

FIG. 17 is a schematic illustration of the deposition of nanorods onto a surface.

FIG. 18 is a schematic illustration of a low-resolution image of deposited nanorods showing centroids, crossings and angles comprising a unique pattern.

FIG. 19 is a low-resolution image (10× objective) of a subset of Nanobarcodes particles.

FIG. 20 is a high-resolution image (63× objective) of a subset of Nanobarcodes particles.

### DETAILED DESCRIPTION OF THE INVENTION

Various embodiments of the present invention provide methods for labeling metal surfaces and objects for identification by attaching encoded metal particles, typically micro- or nanoscale particles referred to herein as nanoparticles.

These particles are subsequently located on the object with an optical microscope and read optically to verify the object's identity. At least some of the nanoparticles are attached in a such a way that they can be located and read without being removed from the tagged object. In all of the embodiments described, particles are attached by a substance referred to herein as the attachment means, typically a solution or suspension.

Attachment methods have two main desired characteristics: robustness and covertness. Robust methods maintain the attachment of the particles to the surface when subjected to various levels of perturbation. In general, robustness is a relative concept and can be defined in part by the perturbation method (e.g., mechanical stress such as rinsing, gentle direct wiping, or sonication; time; air). Covert methods, as defined herein, yield attached particles that cannot be seen by eye without magnification. Because of their size, particles are inherently covert, but the attachment means itself may or may not be covert. In general, the covertness of a particular attachment means varies with the surface to which the particles are attached. For example, a method that is not covert on smooth surfaces may be covert on rough surfaces. These two properties—covertness and robustness—ensure that a counterfeiter or product diverter will neither be aware of the tag nor inadvertently remove it.

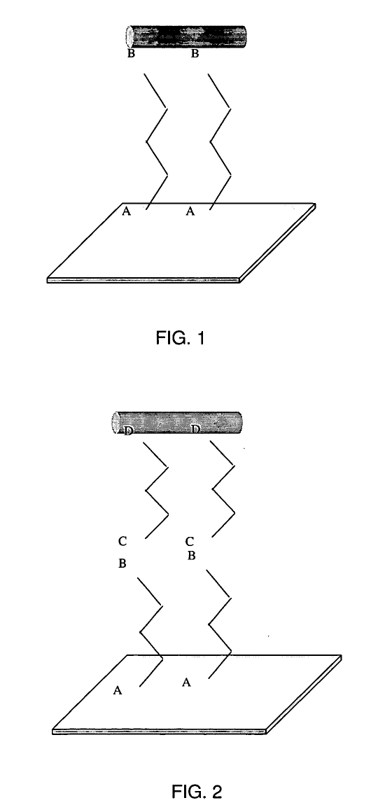

Two broad embodiments of attachment methods are described below. Although these embodiments are described as conceptually different, it will be apparent to one of ordinary skill in the art that aspects of the two embodiments can be combined and that embodiments exist that can be characterized as falling between the two embodiments, as described further below. FIG. 1 illustrates one embodiment of an attachment method of the present invention, referred to as a chemical attachment method. In this method, particles are attached via a compound that has at least two functional groups, each covalently or non-covalently attached to either the particle or the metal surface. The two functional groups, represented in FIG. 1 as A and B, can be the same or different. For example, a useful functional group for linking the attachment means to gold is a thiol group (SH). Another suitable group is an amine group (NH₃). In one embodiment, the compound is a dithiol such as 1,4-benzenedimethanethiol dissolved in, e.g., toluene, but any suitable dithiol may be used. In general, any chemical attachment means providing for sufficiently robust attachment of the particles and surface can be employed. The chemical attachment means illustrated in FIG. 1 are highly structurally simplified and are not intended to limit the structure to that shown.

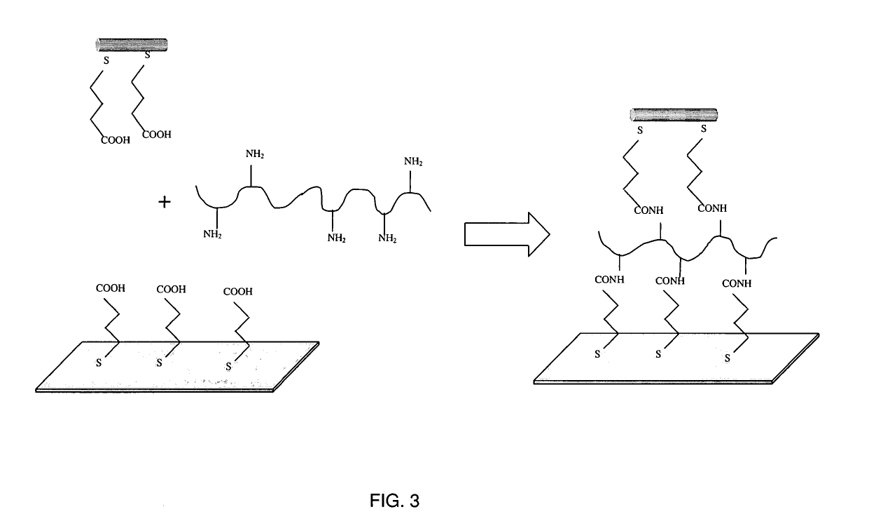

A variation of the chemical attachment method is illustrated schematically in FIG. 2. In this embodiment, referred to as multi-step chemical attachment, particles are attached either via a compound formed by reacting multiple compounds or by a multi-step process in which attachment compounds are attached to both the particle and the surface and then allowed to bind together. As shown in FIG. 2, one starting compound attaches to the particle via functional group D, the other to the surface via functional group A, and then functional groups B and C bind together to complete the attachment of the particle to the surface. The process can be extended to multiple (greater than two) interacting starting compounds. In one example of this embodiment, illustrated schematically in FIG. 3, attachment is achieved through the binding of poly(L-lysine) and mercaptoundecanoic acid (MUA), a particularly useful method for attaching gold-containing particles to gold surfaces. In this case, the thiol groups of MUA bond to the gold of the particle and surface, leaving the carboxylate groups to interact with the amine groups of poly(L-lysine). Various combinations of steps and solutions can be used. For example, the particles and surface can both be coated with MUA, resulting in carboxylate groups presented to the solution. These carboxylate groups can be activated by 1-ethyl-3-(dimethylaminopropyl)carbodiimide hydrochloride (EDC) and N-hydroxysulfosuccinimide (NHS). The particles are then added to the surface with poly(L-lysine), whose amine groups bind to the surface carboxylate groups to attach the particles to the surface. Alternatively, the EDC/NHS-activated MUA-coated particles or surface can be coated with poly(L-lysine) before the particles and surfaces are brought together. In another example, both the particles and the surface are coated with poly(L-lysine), and a crosslinking agent, phenyldiisothiocyanate, is added to link the two poly(L-lysine) coatings together.

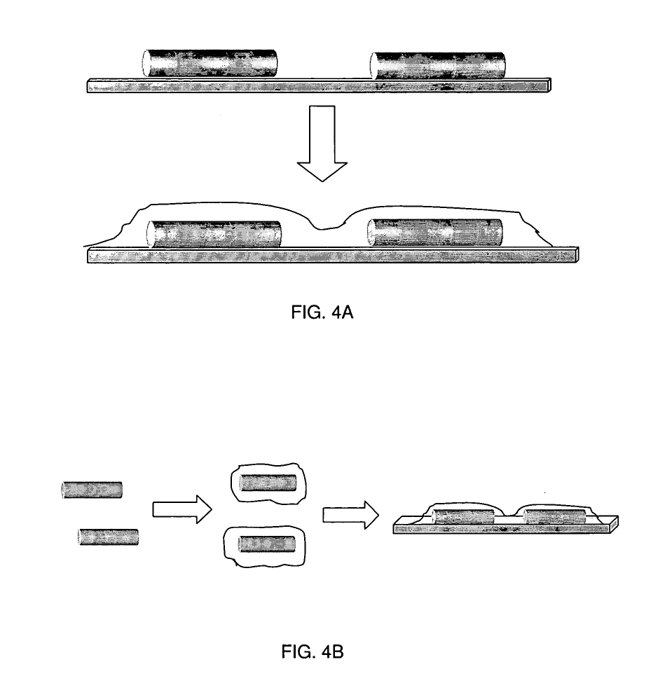

FIGS. 4A and 4B illustrate schematically an alternative broad embodiment of the invention, referred to as film attachment. In these embodiments, the particles are adhered to the surface by a film that either covers the particles and adheres to the surface or is disposed between the particles and the surface to adhere the particles to the surface, or some intermediate configuration. The particles can be deposited on the surface and then covered with the film-forming material, as shown in FIG. 4A, or they can be dispersed or encapsulated in a film-forming material and then deposited on the surface, as shown in FIG. 4B. A very small amount of material can be deposited to enhance its covertness. After deposition, the film's solvent is allowed to evaporate, leaving a dry spot of film encapsulating the particles and attaching them to the surface.

An unlimited number of possible materials may serve as the film-forming material, provided that the material is sufficiently transparent to the wavelength of light at which the particles are located and read. Suitable film-forming materials vary with the particular application. In one embodiment, the film-forming material is an organic polymer, e.g., poly(2-hydroxyethyl methacrylate) (PHEM), in a suitable solvent such as ethanol or butanol. Alternatively, the polymers can be biochemical or biological polymers (biopolymers) such as proteins, peptides, and oligonucleotides. One example of a biopolymer that can serve as the filmforming material is human serum aldbumin (HSA), which forms a relatively thick film. Particles can be combined with the polymer and the resulting dispersion deposited onto the metal surface.

In an alternative embodiment, the film-forming material is a silane, e.g., 3-aminopropyltrimethoxysilane (APTMS) or 3-mercaptopropyltrimethoxysilane (MPTMS). In these two specific examples, the amine or thiol groups attach to the particle surface and to the metal surface, and the silane polymerizes via siloxane bonds to form a network or film encapsulating the particles. In general, any silane having the following formula can be used: 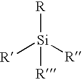
where R, R′, R″, and R′″(“the R groups”) can be any chemical moieties and can be the same or different. At least one of the R groups is capable of attaching to the surface, at least one of the R groups is capable of attaching to the particle, and, in some embodiments, at least one of the R groups is capable of interacting with at least one of the R groups to form a network or film. The particles are mixed with the silane solution (in suitable solvent such as methanol, ethanol, n-propanol, or n-butanol) and allowed to react for a sufficient time. The resulting solution is deposited on the metal surface. Note that silanes can be considered to be both chemical and film attachment means, because they involve both chemical bonds with metal and a film of silane material encapsulating the particle.

Other examples of suitable film-forming materials include, but are not limited to, nail polish, which can be diluted with a solvent such as acetone, methanol, or isopropanol; cyanoacrylate adhesives; or other adhesives or glues, inks, varnishes, lacquers or paints (e.g., enamel or latex). In some embodiments, the resulting film is transparent or translucent with respect to a wavelength, or range of wavelengths. In some embodiments, the resulting film polarizes light. In these examples, it may be desirable to deposit the particles in solvent on the metal surface, allow the solvent to evaporate, and then deposit the film-forming material on top of the particles.

The chemical and film-forming methods can also be combined by first attaching the particles chemically using a chemical attachment means and then covering the attached particles with a film-forming material.

Materials used in different embodiments of the present invention exhibit different levels of covertness. In general, thick films covering the particles tend not to be covert, particularly on smooth, reflective, planar surfaces. For example, the edges of spots of nail polish and thick biopolymers can be seen on these surfaces. However, these films may be covert on rougher or less shiny surfaces or on surfaces located in interior or less conspicuous regions of the labeled object. Chemical attachment methods tend to yield more covert spots of particles. For example, particles secured by PHEM, dithiols, poly(L-lysine) and MUA, and silanes are completely covert on smooth, shiny surfaces, leaving no visible spots. It may be possible to make covert a particular method that initially appears not to be covert. For example, silanes leave a visible residue upon initial application and drying. However, after sonication or, in some cases, rinsing with water, the residue is removed.

Desired robustness levels of the method vary with the particular application. Relevant factors include, but are not limited to, length of time particles must remain on the object before being read, type of handling experienced by the object, and location of the particles on the object. Different particle application methods can be tested for robustness by determining whether the applied particles withstand gentle or forceful rinsing, sonication for various lengths of time, or gentle or forceful wiping or contact. All of the methods described herein are resistant to washing with water, meaning that a detectable number of particles remains attached to the surface after washing. Some, but not all, of the methods are resistant to sonication. Some of the methods are resistant to gentle or more forceful wiping. It may be possible to enhance the effective robustness of the attachment method by placing the particles in a location of the object that is not expected to encounter direct contact. For example, jewelry may have engraved patterns or indentations suitable for placing particles. Particles may also be placed in crevices, recessed surfaces, decorative features, facets, or on or between abutting, adjacent or closely approximated surfaces. An interior surface, e.g., of an earring or watch, may be shielded from contact. In thesecases, it may be necessary to remove the particle before it can be identified.

Note that it is not necessary for all of the particles to remain on the object until verification. Rather, only a number sufficient to allow verification of the code is necessary. In some cases, an object is labeled with multiple differently-coded particles, and at least one of each type must be identified for the code to be determined. The length of time over which the particles must remain attached varies with the application. For some applications, such as tagging antique objects, at least some particles must remain attached for the lifetime of the object. In other applications, it is necessary only for the particles to remain attached until the object arrives at a retailer or at an inspection point. If the packaging and shipping methods prevent contact with and severe or unnecessary agitation of the object, the attachment method may not need to be particularly robust.

Although not true in every case, in some cases there is a tradeoff between robustness and covertness of the attachment method; that is, methods that are more robust tend to be less covert, while covert methods tend to be less robust. This tradeoff should be considered in selecting the optimal attachment method for each particular application. Note also that it is generally more difficult to locate and image the particles on some surfaces, such as curved or rough surfaces, than on smooth, reflective, and planar surfaces.

Techniques for attaching the particles vary based on the particular materials used, but typically involve combining a solution of particles with a solution of the chemical or film-forming attachment means. The resulting solution is allowed to react, if necessary, and agitated by suitable means, if necessary, before being deposited on the metal surface at a desired location using, e.g., a pipette or capillary tube. Relatively small diameter applicators are desired for covert spots. The solution is allowed to dry before the object is handled. Alternatively, the particles can be deposited directly on the surface in solution, the solvent. allowed to evaporate, and a film-forming substance deposited on top of the particles and allowed to dry.

The density, location, and number of deposited particles varies with the object being labeled and the application. High enough particle concentrations are desired to permit observation of a few particles in the microscope field of view, while allowing for removal of some fraction of particles between application and identification. In some cases, the particles can be attached to a landmark of the object, such as an engraved mark, a feature of the object, or a designated region. In one embodiment, the attachment means contain a fluorescent substance that is visible under illumination by light of non-visible wavelength. During object verification, the particles are first located by searching for the spot under the correct illumination. Once located, the particles are observed or imaged under magnification for identification. In one embodiment, the surface to be tagged is coated (e.g., with a coating that minimizes reflections from the surface) before the particles are attached to enhance image quality of the imaged or observed particles.

In general, objects are authenticated by first locating the particles under low magnification using an optical microscope and then imaging or observing the particles under high enough magnification to be able to identify the codes. The identified codes are then compared with a reference or stored value to authenticate the object. Specific identification processes depend on the particular particles and codes employed.

Any suitable encoded metal particles can be used to label metal surfaces in embodiments of the present invention. In one embodiment, the particles are segmented micro- or nanoscale particles such as those described in U.S. patent application Ser. No. 09/677,198, “Assemblies Of Differentiable Segmented Particles,” and U.S. patent application Ser. No. 09/677,203, “Methods of Manufacturing Colloidal Rod Particles as Nanobar Codes,” both filed Oct.2, 2000, and both incorporated herein by reference. These particles are referred to as Nanobarcodes® particles.

Nanobarcodes particles are defined in part by their size and by the existence of at least 2 segments. The length of the particles can be from 10 nm to 50 μm. In some embodiments the particle is 500 nm to 30 μm in length. In the other embodiments, the length of the particles of this invention is 1 to 15 μm. The width, or diameter, of the particles of the invention is within the range of 5 nm to 50 μm. In some embodiments the width is 10 nm to 1 μm, and in other embodiments the width or cross-sectional dimension is 30 to 500 nm.

The Nanobarcodes particles of are frequently referred to as being “rod” shaped. However, the cross-sectional shape of the particles, viewed along the long axis, can have any shape. The Nanobarcodes particles contain at least two segments, and as many as 50. In some embodiments, the particles have from 2 to 30 segments and most preferably from 3 to 20 segments. The particles may have from 2 to 10 different types of segments, preferably 2 to 5 different types of segments. A segment of the particle is defined by its being distinguishable from adjacent segments of the particle.

As discussed above, the Nanobarcodes particles are characterized by the presence of at least two segments. A segment represents a region of the particle that is distinguishable, by any means, from adjacent regions of the particle. In preferred embodiments, the segments are composed of different materials and segments are distinguishable by the change in composition along the length of the particle. In particularly preferred embodiments, the segments are composed of different metals. Segments of the particle bisect the length of the particle to form regions that have the same cross-section (generally) and width as the whole particle, while representing a portion of the length of the whole particle. In some embodiments, a segment is composed of different materials from its adjacent segments. However, not every segment needs to be distinguishable from all other segments of the particle. For example, a particle could be composed of 2 types of segments, e.g., gold and platinum, while having 10 or even 20 different segments, simply by alternating segments of gold and platinum. A particle of the present invention contains at least two segments, and as many as 50. The particles may have from 2 to30 segments and or in other embodiments may have 3 to 20 segments. The particles may have from 2 to 10 different types of segments, preferably 2 to 5 different types of segments.

A segment of the particle is defined by its being distinguishable from adjacent segments of the particle. The ability to distinguish between segments includes distinguishing by any physical or chemical means of interrogation, including but not limited to electromagnetic, magnetic, optical, spectrometric, spectroscopic and mechanical. In certain embodiments of the invention, the method of interrogating between segments is optical (reflectivity).

Adjacent segments may even be of the same material, as long as they are distinguishable by some means. For example, different phases of the same elemental material, or enantiomers of organic polymer materials can make up adjacent segments. In addition, a rod comprised of a single material could be considered a Nanobarcode particle if segments could be distinguished from others, for example, by functionalization on the surface, or having varying diameters. Also particles comprising organic polymer materials could have segments defined by the inclusion of dyes that would change the relative optical properties of the segments. In certain preferred embodiments of the invention, the particles are “functionalized” (e.g., have their surface coated with IgG antibody). Such functionalization may be attached on selected or all segments, on the body or one or both tips of the particle. The functionalization may actually coat segments or the entire particle. Such functionalization may include organic compounds, such as an antibody, an antibody fragment, or an oligonucleotide, inorganic compounds, and combinations thereof. Such functionalization may also be a detectable tag or comprise a species that will bind a detectable tag. Examples of functionalization are described herein. In some embodiments, the functional unit or functionalization of the particle comprises a detectable tag. A detectable tag is any species that can be used for detection, identification, enumeration, tracking, location, positional triangulation, and/or quantitation. Such measurements can be accomplished based on absorption, emission, generation and/or scattering of one or more photons; absorption, emission generation and/or scattering of one or more particles; mass; charge; faradoic or non-faradoic electrochemical properties; electron affinity; proton affinity; neutron affinity; or any other physical or chemical property, including but limited to solubility, polarizability, melting point, boiling point, triple point, dipole moment, magnetic moment, size, shape, acidity, basicity, isoelectric point, diffusion coefficient, or sedimentary coefficient. Such molecular tag could be detected or identified via one or any combination of such properties.

The composition of the particles is best defined by describing the compositions of the segments that make up the particles. A particle may contain segments with extremely different compositions. For example, a single particle could be comprised of one segment that is a metal, and a segment that is an organic polymer material.

The segments of the present invention may be comprised of any material. In preferred embodiments of the present invention, the segments comprise a metal (e.g., silver, gold, copper, nickel, palladium, platinum, cobalt, rhodium, iridium); any metal chalcognide; a metal oxide (e.g., cupric oxide, titanium dioxide); a metal sulfide; a metal selenide; a metal telluride; a metal alloy; a metal nitride; a metal phosphide; a metal antimonide; a semiconductor; a semi-metal. A segment may also be comprised of an organic mono- or bilayer such as a molecular film. For example, monolayers of organic molecules or self assembled, controlled layers of molecules can be associated with a variety of metal surfaces.

A segment may be comprised of any organic compound or material, or inorganic compound or material or organic polymeric materials, including the large body of mono and copolymers known to those skilled in the art. Biological polymers, such as peptides, oligonucleotides and polysaccharides may also be the major components of a segment. Segments may be comprised of particulate materials, e.g., metals, metal oxide or organic particulate materials; or composite materials, e.g., metal in polyacrylamide, dye in polymeric material, porous metals. The segments of the particles of the present invention may be comprised of polymeric materials, crystalline or non-crystalline materials, amorphous materials or glasses.

Segments may be defined by notches on the surface of the particle, or by the presence of dents, divits, holes, vesicles, bubbles, pores or tunnels that may or may not contact the surface of the particle. Segments may also be defined by a discemable change in the angle, shape, or density of such physical attributes or in the contour of the surface. In embodiments of the invention where the particle is coated, for example with a polymer or glass, the segment may consist of a void between other materials.

The length of each segment may be from 10 nm to 50 μm. In some embodiments the length of each segment is 50 nm to 20 μm. Typically, the length is defined as the axis that runs generally perpendicular to lines defining the segment transitions, while the width is the dimension of the particle that runs parallel to the line defining the segment transitions. The interface between segments, in certain embodiments, need not be perpendicular to the length of the particle or a smooth line of transition. In addition, in certain embodiments the composition of one segment may be blended into the composition of the adjacent segment. For example, between segments of gold and platinum, there may be a 5 nm to 5 μm region that is comprised of both gold and platinum. This type of transition is acceptable so long as the segments are distinguishable. For any given particle the segments may be of any length relative to the length of the segments of the rest of the particle.

As described above, the particles can have any cross-sectional shape. In preferred embodiments, the particles are generally straight along the lengthwise axis. However, in certain embodiments the particles may be curved or helical. The ends of the particles may be flat, convex or concave. In addition, the ends- may be spiked or pencil tipped. Sharp-tipped embodiments of the invention may be preferred when the particles are used in Raman spectroscopy applications or others in which energy field effects are important. The ends of any given particle may be the same or different. Similarly, the contour of the particle may be advantageously selected to contribute to the sensitivity or specificity of the assays (e.g., an undulating contour will be expected to enhance “quenching” of fluorophores located in the troughs).

In the present invention, some embodiments of these particles are segmented cylindrical or rod-shaped particles formed from segments of different metals (e.g., gold and silver), which have different light reflectivities at given wavelengths. As a result, reflectance images of the particles appear striped, and the particles are considered to be encoded with a striping pattern. By varying the number of materials, stripes, and stripe thicknesses, a large number of striping patterns may be formed. Combining particles into groups of differently-coded particles increases the number of codes dramatically. Particles can be manufactured by, e.g., sequentially electroplating segments of different metals into templates and releasing the resulting particles from the templates.

The Nanobarcode particles are made in one embodiment by electrochemical deposition in an alumina or polycarbonate template, followed by template dissolution, and typically, they are prepared by alternating electrochemical reduction of metal ions, though they may easily be prepared by other means, both with or without a template material. In the case of the segmented particles described above, suitable methods are described in U.S. patent application Ser. No. 09/677,203, “Method of Manufacture of Colloidal Rod Particles as Nanobar Codes,” filed Oct. 2, 2000, incorporated herein by reference.

When the particles are made by electrochemical deposition the length of the segments (as well as their density and porosity) can be adjusted by controlling the amount of current passed in each electroplating step; as a result, the rod resembles a “bar code” on the nanometer scale, with each segment length (and identity) programmable in advance. Other forms of electrochemical deposition can also yield the same results. For example, deposition can be accomplished via electroless processes and by controlling the area of the electrode, the heterogeneous rate constant, the concentration of the plating material, and the potential. The same result could be achieved using another method of manufacture in which the length or other attribute of the segments can be controlled. While the diameter of the rods and the segment lengths are typically of nanometer dimensions, the overall length is such that in preferred embodiments it can be visualized directly in an optical microscope, exploiting the differential reflectivity of the metal components.

The synthesis and characterization of multiple segmented particles is described in Martin et al., Adv; Materials 11:1021-25 (1999). The article is incorporated herein by reference in its entirety.

Application and readout of particles may take place manually (with an optical microscope, exploiting the differential reflectivity of the particle components, including metal components). Alternatively, both application and readout can be performed automatically. In particular, automated image processing methods can be employed to determine the code of each particle and verify the identity of the labeled object. In the case of the segmented particles described above, suitable methods, including, but not limited to absorbance, fluorescence, Raman, hyperRaman, Rayleigh scattering, hyperRayleigh scattering, CARS, sum frequency generation, degenerate four wave mixing, forward light scattering, back scattering, or angular light scattering), scanning probe techniques (near field scanning optical microscopy, AFM, STM, chemical force or lateral force microscopy, and other variations), electron beam techniques (TEM, SEM, FE-SEM), electrical, mechanical, and magnetic detection mechanisms (including SQUID), are described in U.S. patent application Ser. No. 09/676,890, “Methods of Imaging Colloidal Rod Particles as Nanobar Codes,” filed Oct. 2, 2000, incorporated herein by reference. It may be necessary to tailor software parameters for imaging a particular metal surface to which the particles are attached.

Micro- or nanoscale particles lend themselves to a number of methods for brand security, e.g., blended in a variety of label-specific host mediums such as inks and varnishes and affixed to items. Encoded Nanobarcodes particles; for instance, can be used in serialized tags for track-and-trace applications. The unique characteristics of Nanobarcodes particles (e.g., striping pattern, length, diameter) allows differentiable groups of particles to be created, each group constituting a “type” or “flavor” of particle. Particles of a specific flavor then can be used, alone or in combination with particles of one or more other flavors, to uniquely tag an item. Such methods rely on matching a specific tag to a specific item. In a typical application, the Nanobarcodes particles are synthesized and pre-sorted into groups according to type or flavor before being affixed to an item. The item can be optically examined at a later date to determine the flavor of the affixed particle. In many cases, this is sufficient. However, in some cases, depending on the complexity of the code and the number of different tags required, the method may involve rather sophisticated particle handling technology. In many cases, ink and varnish presses do not have the equipment necessary to accommodate microvolume sorting and handling.

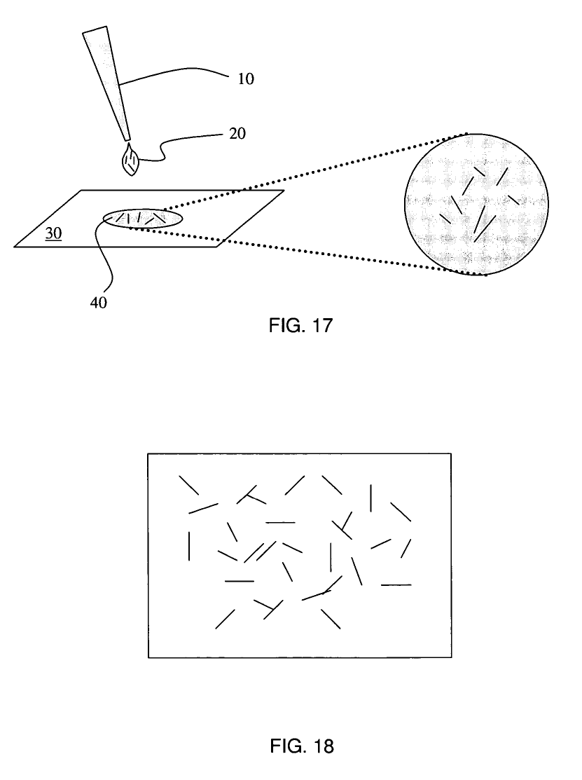

An alternative method for encoding that requires significantly less particle sorting and handling relies on characteristics of the pattern formed by the particles when they are affixed to a surface. For example, a plurality of particles may be suspended in a host medium, such as ink or varnish. In some embodiments, the plurality of particles comprises particles of different types or flavors. Using an applicator 10, aliquots of the mixture 20 may then be deposited on a surface 30 of an item. See FIG. 17. Each aliquot is essentially a “random sample” of the mixture and contains a randomly determined subset of particles. Furthermore, the resulting dispersal of particles 40 forms a pattern that contains a number of features that can then be objectively determined and used as a signature for that item. Some of the features preferentially can be ascertained at low-resolution, some at high-resolution, and some at both low- and high-resolution. The aliquot volume is preferably selected such that the desired quantity of particles is located within an area that is smaller than the field size of the microscope objective being used to interrogate the spot.

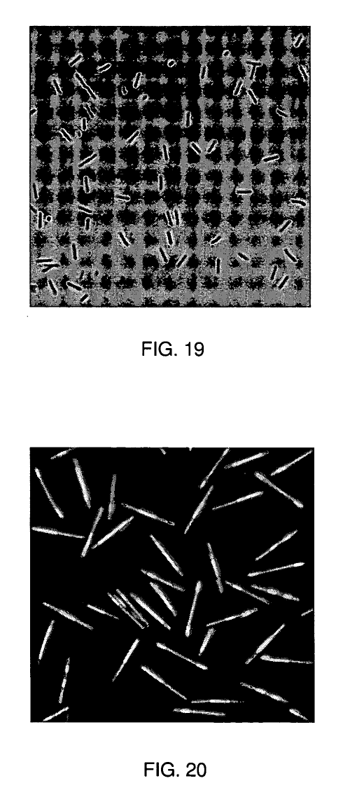

At low-resolution (e.g., 10x), it is typically not possible to determine the flavor of a specific particle. However, the pattern formed by the dispersed particles offers a number of distinguishing features that objectively can be determined. See FIGS. 18 and 19. For example, even at low resolution, it is possible to determine (i) orientation of particle(s) (i.e., the angle) relative to neighboring nanoparticles or landmarks; (ii) relative centroid position of particle(s) with respect to neighboring nanoparticles or landmarks, (iii) crossings of the particles; (iv) overall contrast for nanoparticles sets consisting of a plurality of flavors (e.g., pure silver and pure gold); (v) length of nanoparticles, where particles in the mixture have different lengths; (vi) number of nanoparticles in an image, and/or (vi) one or more of the foregoing. The landmark may be a feature of the tagged item (e.g., a target on the item for depositing the particles), or a specific particle in the dispersion selected for a unique characteristic or according to an (consistently applied) algorithm.

Practice of the method thus would typically involve establishing a rule (or algorithm), applying the rule to determine unique features of a particle dispersion on an article, and maintaining a record of the unique features. The retrospectie identification of the article would be achieved by applying the rule to determine the unique features of a particle dispersion (if any) on an article, and identifying the article by consulting the previously assembled record of unique features.

The benefits of image acquisition at low power include low-cost readers, easy alignment (large depth of focus for sample manipulation), and rapid image/data acquisition. While, the amount of raw data may be less than for a high-resolution image, the information content is nevertheless significant given the number of features that can be measured. Of course, it is not necessary to capture of all of the features for each particle. Only a subset is typically needed to distinguish samples/images.

In practice, a low-resolution image capture may be made of the localized particle dispersion (“spot”) at the time of label production. The features on each spot may then be stored as a record in a database. At a later time, the item can be interrogated to obtain a second low-resolution image of the spot, the features of which can be compared to the database to determine the origin or other information about the item.

At higher resolution, additional features of the particle dispersion are discernable. For example, it may-be possible to determine the flavor of specific particles (e.g., striping pattern of Nanobarcodes particles). See FIG. 20. This increases even further the number of possible combinations and reduces the possibility of a duplicate combination. In an illustrative embodiment, n particles of each of m flavors are pre-mixed with a host medium. Aliquots of the mixture are obtained and deposited on a surface to create a dispersal of particles. Even with relatively modest values of m and n, the mathematical probability of obtaining the exact same subset of flavors in subsequent aliquots is virtually nonexistent. For example, if 50 Nanobarcodes particles are depositied per spot from a 100 flavor library, then mathematically there are 1×10²⁹ possible combinations.

In practice, a high-resolution image capture may be made of the localized particle dispersion (“spot”) at the time of label production. The features on each spot may then be stored as a record in a database. At a later time, the item can be interrogated to obtain a high-resolution image of the spot, the features of which can be compared to the database to determine the origin or other information about the item.

Regardless of image resolution, in preferred embodiments, the nanoparticles are encoded. However, the invention includes embodiments in which the particles are not encoded (e.g., nanorods composed of the same material). Nor do the particles necessarily need to be rod-shaped—for applications where the angle or orientation of the component particles is deteremined, any anisotropic particles could be used. Indeed, for applications where the pattern of nanoparticles is determined, even spherical particles could be used.

The following examples are offered by way of illustration and not by way of limitation.

### EXAMPLES

The examples were performed with the segmented particles referred to above (Nanobarcodes particles). The particles were 6 μm-long and with up to 5 segements made of gold and silver. The particles were stored in water at a concentration of approximately 10⁹ particles per mL. Images were acquired at a wavelength of 405 nm.

### Example 1

### Deposition of Metal Particles on Gold Surfaces

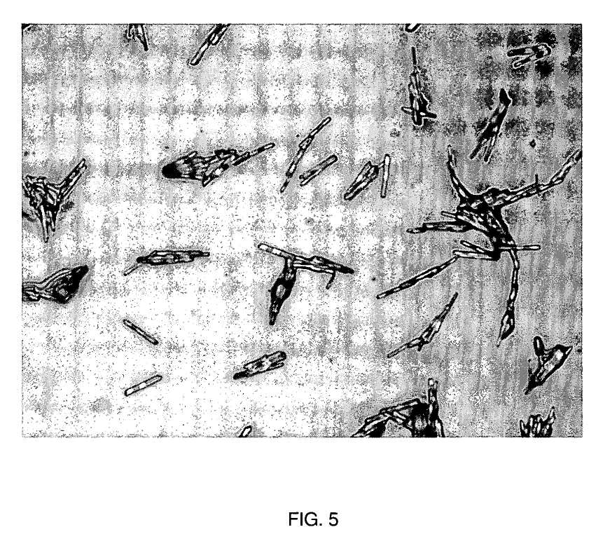

Particles in water at varying concentrations were deposited onto a gold-coated silicon wafer using a glass capillary. The water was allowed to evaporate, resulting in covert spots, and images of the surface were acquired. A representative image is shown in FIG. 5. Particle striping patterns are clearly seen against the gold background. After rinsing with water, few particles remained on the surface.

Glass slides coated with approximately 2 μm of gold were obtained from Dominar, Inc. (Santa Clara, Calif.). Particles in solution in n-butanol were spotted on the gold-coated slides using a glass capillary. These spots were also covert after solvent evaporation, and an easily detectable number of particles remained on the surface after rinsing with water.

### Example 2

### Attachment of Particles to Gold Surface Using Nail Polish

A mixture of differently coded particles was prepared by combining 100 μL each of three particle types with 200 μL of 200 mM mercaptoethanesulfonic acid (MESA). As a control, the particles were deposited onto a Au-coated glass slide and the solvent allowed to evaporate. The particles were imaged, the surface was sonicated for 2 minutes in water, and images were again acquired. After sonication, no detectable particles remained on the surface.

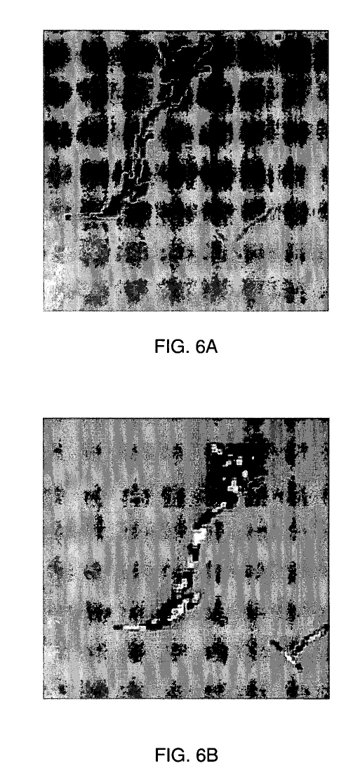

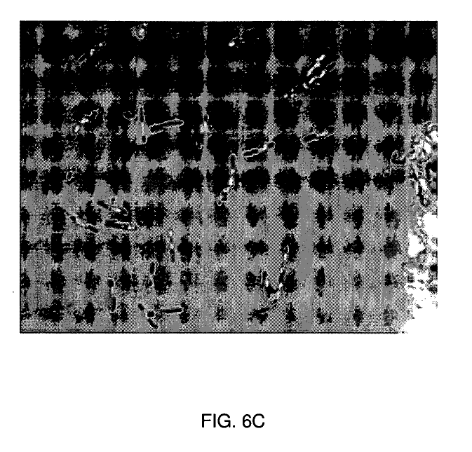

A new batch of the same particles was deposited on the gold surface and the solvent allowed to evaporate. A drop of nail polish solution (4 drops nail polish in 1 mL acetone) was deposited onto the dry particles on the surface and allowed to dry. Images of the particles were acquired using 100× air and 100× oil immersion objectives, shown in FIGS. 6A and 6B, respectively. Using the air objective, particles were seen at the edges of the spots, while the oil immersion objective allowed detection of the particles throughout the film. The surface was then sonicated in water for 2 minutes and images acquired with a 100× oil immersion objective, shown in FIG. 6C. As can be seen by the large number of particles remaining on the surface, nail polish is a relatively robust attachment means, resistant to both sonication and gentle direct wiping. The spots shown were not covert on the planar, smooth gold surface. Similar results were obtained with nail polish diluted with methanol and isopropanol.

### Example 3

### Attachment of Particles to Gold Surface Using Silanes

3-Aminopropyltrimethoxysilane (APTMS) and 3-mercaptopropyltrimethoxysilane (MPTMS) were purchased from Sigma-Aldrich and used as received. 100 μL each of three different particle types in water were mixed with 700 μL of methanol. After the particles settled, the supernatant was removed and the particles rinsed two additional times with methanol to reduce the amount of water. Eight different solutions were prepared by mixing the particles, APTMS, and methanol in different amounts, as shown below:

| Solution | A | B | C | D | E | F | G | H |
|---|---|---|---|---|---|---|---|---|
| Particles (μL) | 50 | 50 | 50 | 50 | 25 | 25 | 25 | 25 |
| APTMS (μL) | 50 | 50 | 50 | 50 | 50 | 50 | 25 | 25 |
| Methanol (μL) | 150 | 100 | 50 | 0 | 25 | 175 | 200 | 300 |

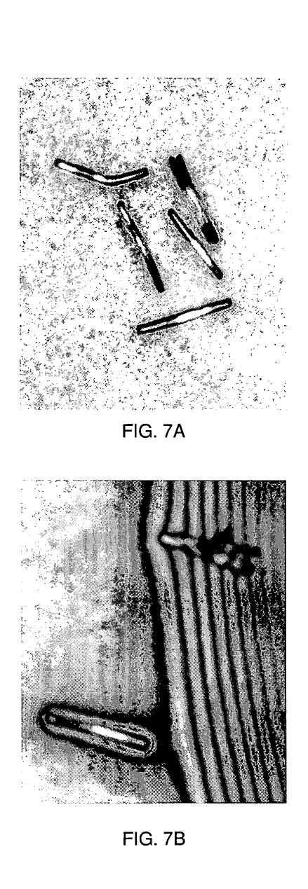

Solutions were allowed to react for at least one hour before being deposited onto a gold-coated glass slide using a 0.1 -mm ID glass capillary. FIG. 7A is an image of a spot of solution A acquired with a 100×, 1.4 NA oil immersion objective. FIG. 7B is an image of a spot of solution F acquired with a 100× air objective, showing both the particle and evidence of the thick APTMS film (large stripes). Both of these spots were covert and resistant to sonication in water for 2 minutes. Similar results were obtained for the remaining solutions.

Solutions of 1, 2, 5 and 10% by volume MPTMS in ethanol were prepared. 400 μL of each solution were combined with 100 μL of particles and allowed to react for at least one hour. The resulting solutions were spotted onto a gold-coated glass slide. Additionally, solutions were prepared of 5, 10, 20 and 50% by volume MPTMS in n-propanol or n-butanol. In each of eight tubes, 50 μL of particles were mixed with 350 μL of ethanol. After the particles settled, the supernatant was removed and one of the MPTMS solutions added to each tube. The solutions were allowed to react for at least one hour and spotted onto a gold-coated glass slide. When dry, the MPTMS left a visible residue that was removed by rinsing with water, leaving covert spots. In all cases, particles remained attached to the surface after sonication in water for 2 minutes.

### Example 4

### Attachment of Particles to Gold Surface Using PHEM

Poly(2-hydroxyethyl methacrylate) (PHEM) was purchased from Scientific Polymer Products, Ontario, N.Y. Solutions of PHEM were prepared in ethanol and n-butanol. The solubility of PHEM in ethanol is such that a solution of 100 mg in 10 mL of ethanol required heating and 2 days to dissolve. A solution of 100 mg of PHEM in n-butanol never completely dissolved, resulting in a saturated solution. To prepare solutions, particles were transferred from water to ethanol or n-butanol and then combined with PHEM in either ethanol or n-butanol. Solutions were spotted onto gold-coated glass slides using glass capillaries having internal diameters ranging from 0.1 to 0.4 mm.

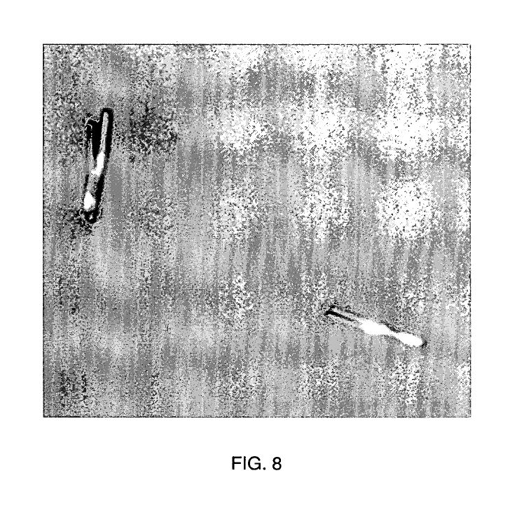

FIG. 8 is an image of particles in a saturated solution of PHEM in n-butanol deposited onto a gold-coated glass slide. The image was acquired with a 100× air objective after the particles were rinsed with water and allowed to dry. This attachment method was not resistant to sonication or physical abrasion of the surface. Spots were not covert, but became less noticeable as the concentration of PHEM was decreased.

### Example 5

### Attachment of Particles to Gold Surface Using Poly(L-Lysine) and MUA

11 -Mercaptoundecanoic acid (MUA), poly(L-lysine) hydrobromide, and phosphate-buffered saline (PBS) were purchased from Sigma-Aldrich and used as received. N-hydroxysulfosuccinimide (NHS) and 1-ethyl-3-(dimethylaminopropyl)carbodiimide hydrochloride (EDC) were obtained from Pierce Scientific and used as received. All chemicals were kept refrigerated until used. MUA solutions were prepared fresh in ethanol before use.

MUA-coated gold surfaces were prepared by placing gold-coated glass slides in solutions of between 20 and 40 mM MUA in ethanol for at least one hour. Slides were removed and rinsed with methanol before use. MUA-coated particles were prepared by centrifuging 100 μL of particles in water at 2000 RCF for 1 minute. The supernatant was removed and 1 mL of 10 mM MUA added. This solution was sonicated and reacted on a tumbler overnight. After reaction, excess MUA was removed by centrifuging the particles, removing the supernatant, and resuspending the particles in 500 μL of ethanol. This procedure was repeated twice. To transfer the MUA-coated particles into water, particles were centrifuged and resuspended in 75% ethanol, followed by successive centrifuging and resuspension in 50% ethanol, 25% ethanol, and water, each time removing ethanol without precipitating any residual MUA.

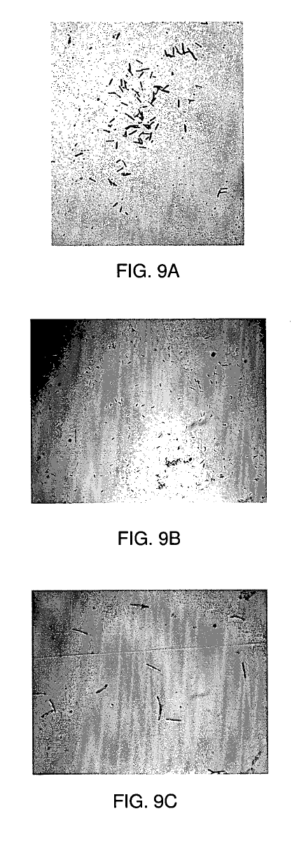

MUA-coated particles were activated with EDC/NHS by incubating 100 μL MUA-coated particles with 500 μL of freshly prepared solution of 100 mM EDC and 40 mM NHS for at least 30 minutes. Particles were centrifuged, the supernatant removed, and 100 μL 10 mM phosphate-buffered saline (PBS) added. This process was repeated twice before poly(L-lysine) was added to the particles. The resulting coated particles were deposited by glass capillary on an EDC/NHS-activated (for at least 30 minutes) MUA-coated gold-coated glass slide. The spots were allowed to dry and rinsed with water. Images were acquired, the surfaces were sonicated in water for 2 minutes, and additional images were acquired. Particles remained attached and were easily detected after rinsing. As shown in FIG. 9A (20× air objective), sonication removed most of the particles from the surface, but a detectable number of particles remained.

In an additional experiment, an activated MUA-coated Au surface was prepared as described above. Poly(L-lysine)-coated particles, prepared as described above, were placed on the surface and mercaptopropylamine (MPA) added. The spot was allowed to dry, rinsed with water, and sonicated in water for two minutes. FIG. 9B is an image of the spot acquired with a 20× air objective. As shown, a large number of particles remain attached to the surface. FIG. 9C shows the same surface imaged with a 100× air objective. Particle striping patterns can be seen clearly.

### Example 6

### Attachment of Particles to Gold Surface Using HSA

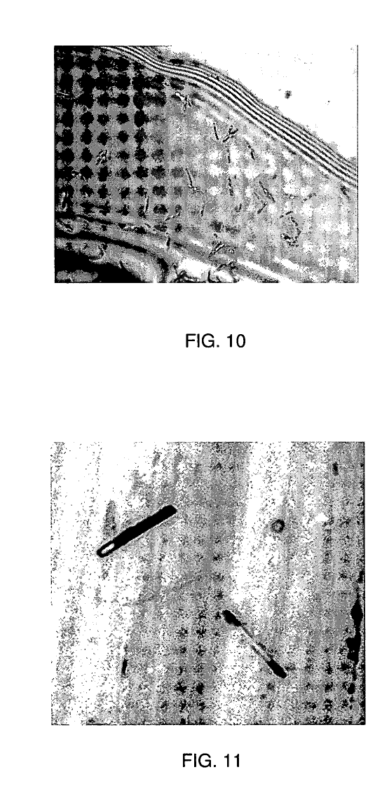

Human serum albumin (HSA) was purchased from Sigma-Aldrich and used as received. Solutions were prepared from 12 mg of solid HSA dissolved in about 1 mL water. 100 μL concentrated particles were placed in the HSA solution, sonicated, and tumbled for at least one hour. The resulting particle solution was diluted 1/10 with water and deposited onto a gold-coated glass slide with a glass capillary. The surface was sonicated for 2 minutes in water and an image acquired (FIG. 10) using a 100× air objective. Particles are clearly seen in a thick film of HSA. These spots were robust but not covert on the smooth gold surface.

### Example 7

### Attachment of Particles to Stainless Steel Watch

A mixture was prepared from 2 parts PHEM in butanol (saturated solution) and 1 part particles in ethanol. Particles were deposited by a glass capillary onto the inside surface of a stainless steel watch back. The surface was rinsed with water, yielding a covert spot. Images of the spot were acquired using a 100× air objective (FIG. 11). Particles and their codes are clearly visible on the rough surface under magnification.

### Example 8

### Attachment of Particles to Gold Watch

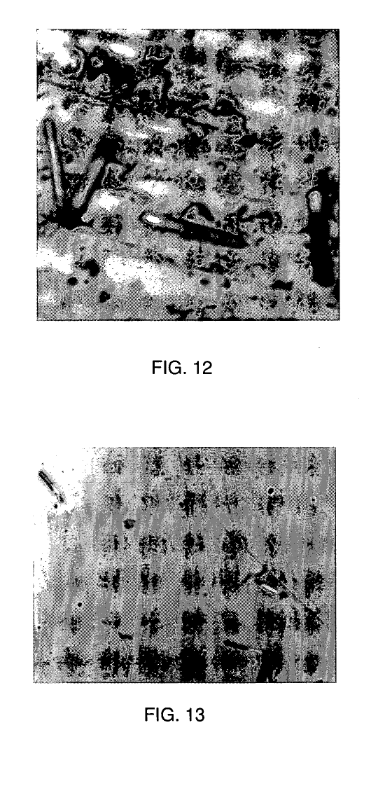

A mixture was prepared from 2 parts PHEM in butanol (saturated solution) and 1 part particles in ethanol. Particles were deposited by a glass capillary onto the engraver's mark on the inside surface of a gold watch back. The surface was rinsed with water, yielding a covert spot. Images of the spot were collected using a 100× air objective (FIG. 12). Particles and their codes are clearly visible on the rough surface under magnification.

### Example 9

### Attachment of Particles to Gold Earring

A mixture was prepared from 2 parts PHEM in butanol (saturated solution) and 1 part particles in ethanol. Particles were deposited by a 0.4-mm ID glass capillary near engraved marks on a gold earring. The surface was rinsed with water, yielding a covert spot. Images of the spot were collected using a 100× air objective (FIG. 13). Particles and their codes are clearly visible on the rough surface under magnification.

### Example 10

### Attachment of Particles to White Gold Ring

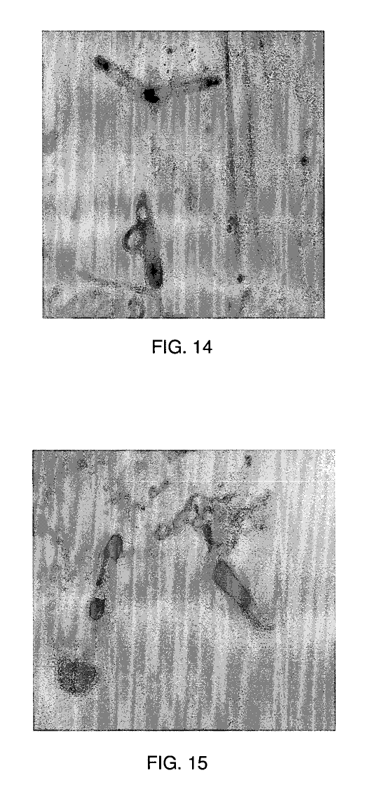

A mixture was prepared from 2 parts PHEM in butanol (saturated solution) and 1 part particles in ethanol. Particles were deposited by a 0.4-mm ID glass capillary near engraved marks on a white gold ring. The surface was rinsed with water, yielding a covert spot. Images of the spot were collected using a 100× air objective (FIG. 14). Particles and their codes are clearly visible on the rough surface under magnification.

### Example 11

### Attachment of Particles to Pen

A mixture was prepared from 2 parts PHEM in butanol (saturated solution) and 1 part particles in ethanol. Particles were deposited by a 0.4-mm ID glass capillary onto the inside of a stainless steel pen barrel. The surface was allowed to dry, yielding a covert spot. Images of the spot were collected using a 100× air objective (FIG. 15). Particles and their codes are clearly visible on the rough surface under magnfication.

### Example 12

### Attachment of Particles to Coated Watch

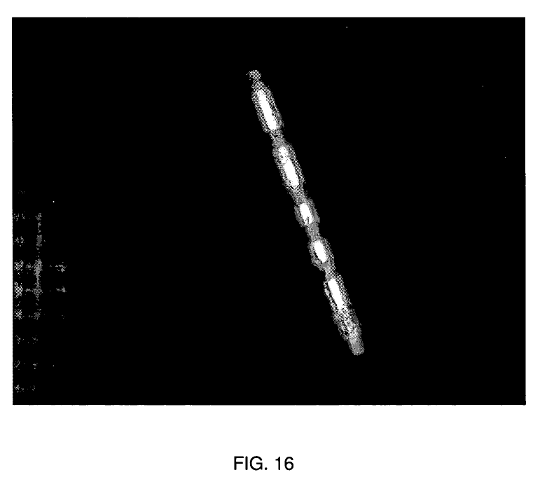

The back stainless steel surface of a watch was darkened using a black felt-tip pen. A solution of particles in water was deposited by glass capillary into an engraved crevice of the blackened watch surface and an image acquired using a 50× air objective, shown in FIG. 16. Particles tended to align with the longitudinal direction of the crevice, which had a flat bottom surface. The darkened metal surface yielded a very high-contrast image, allowing the particle to be located and decoded using particle-reading software.

It should be noted that the foregoing description is only illustrative of the invention. Various alternatives and modifications can be devised by those skilled in the art without departing from the invention. Accordingly, the present invention is intended to embrace all such alternatives, modifications and variances which fall within the scope of the disclosed invention.

1. A method for labeling a metal surface for identification, comprising chemically attaching an encoded metal particle to said surface such that said attached metal particle is detectable by optical microscopy.

2. The method of claim 1 wherein said metal particle is chemically attached via a compound having at least two functional groups.

3. The method of claim 2, wherein at least one of said functional groups is a thiol group.

4. The method of claim 3, wherein said compound is a dithiol.

5. The method of claim 4, wherein said compound is 1,4-benzenedimethanethiol.

6. The method of claim 2, wherein at least one of said functional groups is an amine group.

7. The method of claim 2, wherein said compound is formed from at least two starting compounds, each having at least two functional groups.

8. The method of claim 7, wherein at least one of said starting compounds is poly(L-lysine).

9. The method of claim 7, wherein at least one of said starting compounds is a carboxy-terminated alkanethiol.

10. The method of claim 2, wherein said compound is a polymeric compound.

11. The method of claim 1, wherein said surface is a curved surface.

12. The method of claim 1, wherein said surface is a rough surface.

13. The method of claim 1, wherein said surface is a surface of a piece of jewelry.

20. A method for labeling a metal surface for identification, comprising at least partially coating an encoded metal particle with a film-forming substance and depositing said particle on said metal surface, wherein said particle on said surface is detectable by optical microscopy.

21. The method of claim 20, wherein said particle is coated before said particle is deposited on said surface.

22. The method of claim 20, wherein said particle is deposited on said surface before said particle is coated.

23. The method of claim 20, wherein said film-forming substance contains at least one functional group capable of bonding to said particle.

24. The method of claim 20, wherein said film-forming substance contains at least one functional group capable of bonding to said surface.

25. The method of claim 20, wherein said film-forming substance comprises a silane.

26. The method of claim 25, wherein said silane is chosen from at least one of APTMS and MPTMS.

27. The method of claim 20, wherein said film-forming substance comprises a polymer.

28. The method of claim 27, wherein said polymer is a biopolymer.

29. The method of claim 28, wherein said biopolymer is a protein.

30. The method of claim 27, wherein said polymer is poly(2-hydroxyethyl methacrylate).

31. The method of claim 20, wherein said surface is a curved surface.

32. The method of claim 20, wherein said surface is a rough surface.

33. The method of claim 20, wherein said surface is a surface of a piece of jewelry.

34. An encoded metal particle attached to a surface, wherein said attachment is effected by a compound having at least two functional groups.

35. The encoded metal particle attached to a surface of claim 34, wherein at least one of said functional groups is a thiol group or an amine group.

36. The encoded metal particle attached to a surface of claim 35, wherein said compound is a dithiol.

37. The encoded metal particle attached to a surface of claim 34, wherein said compound is formed from at least two starting compounds, each having at least two functional groups.

38. The encoded metal particle attached to a surface of claim 37, wherein at least one of said starting compounds is poly(L-lysine).

39. The encoded metal particle attached to a surface of claim 37, wherein at least one of said starting compounds is a carboxy-terminated alkanethiol.

40. The encoded metal particle attached to a surface of claim 1, wherein said compound is a polymeric compound.

41. The method of claim 1, wherein said surface is selected from the group consisting of a curved surface, a rough surface, and the surface of a piece of jewelry.

42. An encoded metal particle attached to a surface, wherein said attachment is effected by a film-forming substance.

43. The encoded metal particle attached to a surface of claim 42, wherein said particle is coated before said attachment to said surface.

44. The encoded metal particle attached to a surface of claim 42; wherein said particle, wherein said particle is coated after said attachment to said surface.

45. The encoded metal particle attached to a surface of claim 42, wherein said film-forming substance contains at least one functional group capable of bonding to said particle.

46. The encoded metal particle attached to a surface of claim 42, wherein said film-forming substance contains at least one functional group capable of bonding to said surface.

47. The encoded metal particle attached to a surface of claim 42, wherein said film-forming substance comprises a silane.

48. The encoded metal particle attached to a surface of claim 47, wherein said silane is chosen from at least one of APTMS and MPTMS.

49. The encoded metal particle attached to a surface of claim 42, wherein said film-forming substance comprises a polymer.

50. The encoded metal particle attached to a surface of claim 49, wherein said polymer is a biopolymer.

51. The encoded metal particle attached to a surface of claim 50, wherein said biopolymer is a protein.

52. The encoded metal particle attached to a surface of claim 49, wherein said polymer is poly(2-hydroxyethyl methacrylate).

53. The method of claim 42, wherein said surface is selected from the group consisting of a curved surface, a rough surface, and the surface of a piece of jewelry.
